(19) United States
(12) Patent Application Publication
(10) Pub. No.: US 2024/0174949 A1
(43) Pub. Date: May 30, 2024

(54) LAUNDRY COMPOSITION

(71) Applicant: RECKITT BENCKISER VANISH B.V., Hoofddorp (NL)

(72) Inventors: Anna DEL MONACO, Mira (IT); Andrea D'ISEPPI, Mira (IT); Elena GRANCI, Mira (IT); Monica LOPEZ, Mira (IT); Sara QUAGGIA, Mira (IT); Claudia SORATO, Mira (IT); Luca SPADONI, Mira (IT)

(21) Appl. No.: 18/546,288

(22) PCT Filed: Feb. 17, 2022
(86) PCT No.: PCT/EP2022/053892

§ 371 Date: Aug. 14, 2023

(30) Foreign Application Priority Data
Feb. 19, 2021 (GB) 2102325.4

(51) Int. Cl. C11D 3/00; C11D 3/37; C11D 3/386; C11D 3/395; C11D 3/50

(52) U.S. Cl. CPC C11D 3/0021; C11D 3/3776; C11D 3/38609; C11D 3/38627; C11D 3/38636; C11D 3/38645; C11D 3/3951; C11D 3/50; C11D 2111/12

(57) ABSTRACT

The present invention relates to a laundry composition for the removal of stains, which comprises at least one bleaching agent, at least one bleach activator, and a dye transfer inhibitor system comprising a copolymer of 1-vinyl-2-pyrrolidone and 1-vinylim-idazole, and a homopolymer of 1-vinyl-2-pyrrolidone: wherein the weight ratio between the copolymer of 1-vinyl-2-pyrrolidone and 1-vinylimidazole and the homopolymer of 1-vinyl-2-pyrrolidone is of between 1:1 to 5:1. It also relates to a method of washing a garment using the laundry composition and to the use of the laundry composition for the removal of stains from a garment and dye transfer reduction or inhibition from a garment.

The present invention relates to a laundry composition, to a method of washing a garment using the laundry composition, and to the use of the composition for the removal of stains from a garment, preferably stains comprising a polyphenolic compound, such as turmeric and/or curry stains, and dye transfer reduction or inhibition from a garment.

### BACKGROUND

Consumers associate desirability and wearability of a garment with characteristics such as e.g. absence of stains or absence of colour fading. It is preferred when both characteristics are achieved in a simple way.

The removal of stains is achieved using bleaching agents, surfactants and/or enzymes. For example, enzymatic stains require enzymes, oil-based stains require enzymes or a combination of surfactants, bleachable stains require a bleaching agent to remove them.

Although, bleachable stains may be removed with bleaching agents, this often leads to discoloration or dye transfer from a garment. Therefore, it is not an easy task to remove bleachable stains whilst inhibiting colour fading or dye transfer.

In addition, some stains contain polyphenols, which are naturally occurring compounds having multiples of phenol units. Examples of polyphenol-containing foods are tea, red wine, curry, and chocolate. These compounds have been used as dyes and for tanning garments; which gives an idea that it is complicated to remove stains of polyphenolic compound soils from a garment.

Curcumin is a yellow active ingredient in turmeric spice; it is a hydrophobic polyphenol derived from the rhizome of turmeric (Curcuma longa). Foods prepared with blends of spices containing turmeric or curry lead to stains that are impossible to remove with common laundry detergents, chlorine bleaches, existing laundry additives or any home remedies. Turmeric is a strong natural colorant and the additional presence of oil, fat, meat and other protein components like egg and milk make this type of stains even more complicated to clean. This means that in cuisines where curry/turmeric plays an important role, people are left with no solution and they have no choice than to cope with curry/turmeric stains residues on their garments, even after washing.

For the removal of stains containing polyphenols, bleaching agents, preferably in combination with enzymes, are normally used. Again, this often leads to discolouration or dye transfer from a garment. Document EP1941015 describes compositions comprising a catechol for the removal of polyphenolic compound soils. However, this document does not describe the combined effect of removing stains comprising a polyphenolic compound and dye transfer inhibition from a garment.

To avoid discolouration or dye transfer from a garment, dye transfer inhibitors are commonly used. Preferred dye-transfer inhibitors (sometimes called dye anti-redisposition agents or soil suspending agents) include polyvinylalcohol, fatty amides, sodium carboxylmethyl cellulose, hydroxypropyl methyl cellulose, homopolymers of 1-vinyl-2-pyrrolidone (PVP), polyvinylimidazole, polyvinyloxoazolidone, polyamine N-oxide polymers and copolymers or 1-vinyl-2-pyrrolidone and 1-vinylimidazole (PVP-VI). It is known by the person skilled in the art that some dye transfer inhibitors work better for colours in the blue range, e.g. PVP, whilst other inhibitors work better in the red range, e.g. PVP-VI. However, to inhibit dye transfer in the yellow range is difficult.

Furthermore, it will be recognised by the person skilled in the art that compounds such as PVP-VI are expensive, and it is desirable to replace all of part of them with other dye transfer inhibitors.

The activity of dye transfer inhibitors can be reduced by traditional bleaching agents, such as hydrogen peroxide, peroxide compounds and/or peroxyacids. Some solutions have been proposed to achieve stain removal of compositions comprising dye transfer inhibitors. EP1268731 describes bleaching compositions based on atmospheric oxygen, without hydrogen peroxide or a source of hydrogen peroxide, comprising a ligand which forms a complex with a transition metal. EP0964910 describes compositions comprising a xylan degrading enzyme. EP0907703 describes compositions comprising modified polyamines to provide dye transfer inhibition in the presence of bleaching agents.

Therefore, there is a need of a laundry composition capable of removing stains, in particular those comprising a polyphenolic compound, such as turmeric and/or curry stains, whilst inhibiting dye transfer from a garment. Dye transfer should be prevented not only from colours in the red and blue ranges, but preferably also in the yellow range. Preferably the laundry composition should comprise traditional bleaching agents.

It is an object of the present invention to provide a laundry composition that provides a solution for this need.

To this end, the present disclosure provides a laundry composition comprising at least one bleaching agent, at least one bleach activator, and a dye transfer inhibitor system comprising a copolymer of 1-vinyl-2-pyrrolidone and 1-vinylimidazole, and a homopolymer of 1-vinyl-2-pyrrolidone; wherein the weight ratio between the copolymer of 1-vinyl-2-pyrrolidone and 1-vinylimidazole and the homopolymer of 1-vinyl-2-pyrrolidone is of between 1:1 to 5:1.

### SUMMARY OF THE INVENTION

In a first aspect, the present invention relates to a laundry composition comprising at least one bleaching agent, at least one bleach activator, and a dye transfer inhibitor system comprising a copolymer of 1-vinyl-2-pyrrolidone and 1-vinylimidazole, and a homopolymer of 1-vinyl-2-pyrrolidone; wherein the weight ratio between the copolymer of 1-vinyl-2-pyrrolidone and 1-vinylimidazole and the homopolymer of 1-vinyl-2-pyrrolidone is of between 1:1 to 5:1.

In an embodiment, the copolymer of 1-vinyl-2-pyrrolidone and 1-vinylimidazole has a molecular weight of between 10 000 g/mol and 500 000 g/mol, preferably between 20 000 g/mol and 250 000 g/mol, more preferably between 30 000 g/mol and 150 000 g/mol, even more preferably between 40 000 g/mol and 100 000 g/mol.

In another embodiment, the homopolymer of 1-vinyl-2-pyrrolidone has a molecular weight of between 10 000 g/mol and 200 000 g/mol, preferably between 20 000 g/mol and 100 000 g/mol, more preferably between 30 000 g/mol and 50 000 g/mol, even more preferably between 35 000 g/mol and 45 000 g/mol.

The weight ratio between the copolymer of 1-vinyl-2-pyrrolidone and 1-vinylimidazole and the homopolymer of 1-vinyl-2-pyrrolidone may be of between 1.1:1 to 4:1, preferably between 1.2:1 to 3:1, more preferably between 1.3:1 to 2:1.

In an embodiment, the composition comprises between 0.01 wt. % and 10 wt. % of the dye transfer inhibitor system, based on the total weight of the composition, preferably between 0.05 wt. % and 7.5 wt. %, more preferably between 0.1 wt. % and 5 wt. %, even more preferably between 0.2 wt. % and 2.5 wt. %.

In another embodiment, the composition comprises between 10 wt. % and 60 wt. % of the at least one bleaching agent, based on the total weight of the composition, preferably between 20 wt. % and 55 wt. %, more preferably between 30 wt. % and 50 wt. %, even more preferably between 35 wt. % and 45 wt. %.

The at least one bleaching agent may comprise at least one source of active oxygen selected from the group consisting of an inorganic peroxide, an organic peracid, hydrogen peroxide, and combinations thereof; preferably selected from the group consisting of sodium percarbonate, ε-phthalimido-peroxy-hexanoic acid (PAP), peracetic acid, potassium peroxymonosulfate (KMPS), and combinations thereof; most preferably wherein the at least one bleaching agent comprises or consist of sodium percarbonate.

In an embodiment, the composition comprises between 0.1 wt. % and 20 wt. % of the at least one bleach activator, based on the total weight of the composition, preferably between 0.25 wt. % and 15 wt. %, more preferably between 0.5 wt. % and 10 wt. %, most preferably between 1 wt. % and 5 wt. %.

In another embodiment, the composition comprises between 0.01 wt. % and 20 wt. % of at least one surfactant, based on the total weight of the composition, preferably between 0.05 wt. % and 15 wt. %, more preferably between 0.1 wt. % and 10 wt. %, even more preferably between 0.5 wt. % and 5 wt. %, most preferably between 0.5 wt. % and 4 wt. %.

In a preferred embodiment, the composition comprises at least one enzyme, preferably selected from the group consisting of a mannanase, a lipase, an amylase, a cellulase, a protease, and combinations thereof.

The pH of a dilution of 1:100 at 20° C. of the composition may be between 8 and 12, preferably between 9 and 11.5, more preferably between 9.5 and 11.5, even more preferably between 10 and 11.

In an embodiment, the composition is in the form of a solid, a powder or mixtures thereof

In another embodiment, the composition is a laundry detergent composition or a laundry additive composition, preferably wherein said composition is a laundry additive composition.

In a second aspect, the invention relates to a method of washing a garment, comprising:
washing a garment with the laundry composition according to the first aspect of the invention; or
washing a garment with a mixture comprising a laundry detergent composition and the laundry composition according to the first aspect of the invention; or
adding a laundry composition according to the first aspect of the invention to a bucket with water and soaking for a predetermined length of time; or
   a) pre-treating the garment with the laundry composition according to the first aspect of the invention; and
   b) washing the pre-treated garment of step a) with the laundry composition according to the first aspect of the invention, or a laundry detergent composition, or with a mixture comprising a laundry detergent composition and the laundry composition according to the first aspect of the invention.

In a third aspect, the invention relates to a use of the laundry composition according to the first aspect of the invention for the removal of stains from a garment and dye transfer reduction or inhibition from a garment.

In one embodiment, the stains comprise a polyphenolic compound, preferably wherein the stains comprise turmeric and/or curry stains.

### Definitions

The following definitions are used in the present application.

“Protease” as used in the present application means: class of enzymes that catalyse the breakdown of proteins into smaller polypeptides or single amino acids.

“Amylase” as used in the present application means: class of enzymes that catalyse the hydrolysis of starch into sugars such as glucose and maltose.

“Mannanase” as used in the present application means: class of enzymes that catalyse the hydrolysis of mannose derivatives.

“Mannose” as used in the present application means: sugar monomer of the aldohexose series of carbohydrates.

“Lipase” as used in the present application means: class of enzymes that catalyse the hydrolysis of fats or lipids.

“Cellulase” as used in the present application means: class of enzymes that catalyse the cellylolysis or hydrolysis of cellulose.

“Laundry composition” as used in the present application means: compositions which can be used for pre-treating a garment before washing the garment with a laundry detergent, and/or that can be used alone for washing a garment, and/or that can be used together with the laundry detergent during washing of the garment, and/or that can be used as a rinse cycle composition. With other words, the laundry composition can be used alone for washing a garment or can be used as an auxiliary of the laundry detergent. A laundry composition includes, but is not limited to, products for the care of garments, removal of stains, cleaning of garments, sanitisation of garments, disinfecting of garments, and stain removers.

“Laundry detergent composition” as used in the present application means: composition used solely for the cleaning of garments and whose main action is the removal of grim and dirt, comprising a builder and not having lipases.

“Laundry additive composition” as used in the present application means: composition which is used for providing a specific consumer benefit, such as: removal of stains, elimination of malodour, improvement of whiteness, prevention or colour transfer, and/or disinfection of garments. This means that the mean action of a laundry additive is not the removal or grim and dirt. Furthermore, a laundry additive is commonly used as a pre-treatment, in soaking conditions or together with a laundry detergent composition.

### DETAILED DESCRIPTION OF THE INVENTION

In a first aspect, the present invention relates to a laundry composition comprising at least one bleaching agent, at least one bleach activator, and a dye transfer inhibitor system comprising a copolymer of 1-vinyl-2-pyrrolidone and 1-vinylimidazole, and a homopolymer of 1-vinyl-2-pyrrolidone; wherein the weight ratio between the copolymer of 1-vinyl-2-pyrrolidone and 1-vinylimidazole and the homopolymer of 1-vinyl-2-pyrrolidone is of between 1:1 to 5:1.

The present inventors have surprisingly observed a synergistic effect between a copolymer of 1-vinyl-2-pyrrolidone and 1-vinylimidazole, and a homopolymer of 1-vinyl-2-pyrrolidone. This effect is shown in the stain removal and dye transfer reduction or inhibition properties of a composition comprising these compounds, at least one bleaching agent an at least one bleach activator. The weight ratio between the copolymer of 1-vinyl-2-pyrrolidone and 1-vinylimidazole and the homopolymer of 1-vinyl-2-pyrrolidone must be of between 1:1 to 5:1.

The composition according to the invention provides, in particular, removal of polyphenolic compounds soils and dye transfer inhibition or reduction from the textiles washed with the composition, especially removal of turmeric and/or curry stains. Without wishing to be bound by any theory, the present inventors believe that the PVP in the composition not only aids with the dye transfer inhibition, but also helps solubilising polyphenolic compounds, such as turmeric, which leads to the combined effect of dye transfer inhibition and removal of stains.

Furthermore, the composition is suitable for reducing dye transfer not only from colours in the blue or red range, but, in particular, from colours in the yellow range.

The present inventors have further observed, that with the weight ratio between the copolymer of 1-vinyl-2-pyrrolidone and 1-vinylimidazole and the homopolymer of 1-vinyl-2-pyrrolidone, according to the invention, it is possible to obtain a dye transfer inhibition which is similar or superior than when only PVP-VI is used. This means that part of the PVP-VI can be replaced by PVP.

In one embodiment, the copolymer of 1-vinyl-2-pyrrolidone and 1-vinylimidazole has a molecular weight of between 10 000 g/mol and 500 000 g/mol, preferably between 20 000 g/mol and 250 000 g/mol, more preferably between 30 000 g/mol and 150 000 g/mol, even more preferably between 40 000 g/mol and 100 000 g/mol. A preferred example of PVP-VI is Sokalan HP56 (granules) ex. BASF, which has a molecular weight of about 70 000 g/mol.

In another embodiment, the homopolymer of 1-vinyl-2-pyrrolidone has a molecular weight of between 10 000 g/mol and 200 000 g/mol, preferably between 20 000 g/mol and 100 000 g/mol, more preferably between 30 000 g/mol and 50 000 g/mol, even more preferably between 35 000 g/mol and 45 000 g/mol. A preferred example of PVP-VI is Sokalan HP50 (granules) ex. BASF, which has a molecular weight of about 40 000 g/mol.

As used herein the term molecular weight refers to the weight average molecular weight.

The weight ratio between the copolymer of 1-vinyl-2-pyrrolidone and 1-vinylimidazole and the homopolymer of 1-vinyl-2-pyrrolidone may be of between 1.1:1 to 4:1, preferably between 1.2:1 to 3:1, more preferably between 1.3:1 to 2:1.

In a preferred embodiment, the dye transfer inhibitor system comprises:
a copolymer of 1-vinyl-2-pyrrolidone and 1-vinylimidazole having a molecular weight of between 40 000 g/mol and 100 000 g/mol,
a homopolymer of 1-vinyl-2-pyrrolidone having a molecular weight of between 35 000 g/mol and 45 000 g/mol;
wherein, the weight ratio between the copolymer of 1-vinyl-2-pyrrolidone and 1-vinylimidazole and the homopolymer of 1-vinyl-2-pyrrolidone is of between 1.1:1 to 4:1, preferably between 1.2:1 to 3:1, more preferably between 1.3:1 to 2:1.

The composition may comprise between 0.01 wt. % and 10 wt. % of the dye transfer inhibitor system, based on the total weight of the composition, preferably between 0.05 wt. % and 7.5 wt. %, more preferably between 0.1 wt. % and 5 wt. %, even more preferably between 0.2 wt. % and 2.5 wt. %.

### Bleaching Agent

The bleaching agent may comprise at least one source of active oxygen selected from the group comprising an inorganic peroxide, an organic peracid, hydrogen peroxide, and combinations thereof; preferably selected from the group comprising sodium percarbonate, ε-phthalimido-peroxy-hexanoic acid (PAP), peracetic acid, potassium peroxymonosulfate (KMPS), and combinations thereof; most preferably wherein said at least one bleaching agent comprises or consist of sodium percarbonate.

The person skilled in the art will recognise that these sources of active oxygen are traditional bleaching agents. The present inventors have surprisingly observed that the combination of PVP and PVP-VI as described herein allows for the use of traditional bleaching agents, without significant reduction of the activity of the bleaching agent or the dye transfer inhibitor system.

The composition may comprise between 10 wt. % and 60 wt. % of the at least one bleaching agent, based on the total weight of the composition, preferably between 20 wt. % and 55 wt. %, more preferably between 30 wt. % and 50 wt. %, even more preferably between 35 wt. % and 45 wt. %. Even at such high concentration of bleaching agent no reduction of the activity of the dye transfer inhibitor system is observed. On the contrary, there is a synergy between the dye transfer inhibitor system and the bleaching agent.

### Bleach Activator

The composition may comprise between 0.1 wt. % and 20 wt. % of the at least one bleach activator, based on the total weight of the composition, preferably between 0.25 wt. % and 15 wt. %, more preferably between 0.5 wt. % and 10 wt. %, most preferably between 1 wt. % and 5 wt. %.

The at least one bleach activator is preferably selected from the group consisting of tetraacetylethylendiamine (TAED), acetylated triazine derivatives, acetylated glycoluriles, acylimides, acetylated phenolsulfonates, acetylated phenol carbonic acids, carbonic acid anhydrides, acetylated sugar derivatives, N-acetylated lactams, and combinations thereof; preferably said at least one bleach activator comprises or consists of tetraacetylethylendiamine (TAED).

### Surfactants

The composition may comprise at least one surfactant. The at least one surfactant may comprise a non-ionic, anionic, cationic, amphoteric or zwitterionic surface active agents or suitable mixtures thereof may be used. Many such suitable surfactants are described in Kirk Othmer's Encyclopedia of Chemical Technology, 3rd Ed., Vol. 22, pp. 360-379, “Surfactants and Detersive Systems”.

For example, the surfactant may comprise one or more non-ionic surfactants, preferably ethoxylated alcohols and ethoxylated alkyl phenols having the formula R1(OCH₂CH₂)ₙOH; wherein R1 is an aliphatic hydrocarbon radicals containing between 10 and 24 carbon atoms or alkyl phenyl radicals in which the alkyl groups contain from 10 to 22 carbon atoms; and n has an average value of from 1 to 10.

The surfactant may comprise any conventional anionic surfactant or a mixture of them used in detergent products. These include, for example, the alkyl benzene sulfonic acids and their salts as well as alkoxylated or non-alkoxylated alkyl sulfate materials. The anionic surfactants may be present in acid form or in neutralized (e.g., salt) form. The anionic surfactants may be linear, branched, or a mixture thereof. An example of an anionic surfactant is sodium cumenesulphonate.

Examples of anionic surfactants are the alkali metal salts of C10-16 alkyl benzene sulphonic acids or C11-14 alkyl benzene sulphonic acids.

Another exemplary type of anionic surfactant is alkoxylated alkyl sulphate surfactants, such as ethoxylated alkyl sulphate surfactants. Such materials are also known as alkyl ether sulphates or alkyl polyethoxylate sulphates.

Alkyl ether sulphates are generally available in the form of mixtures comprising varying R′ chain lengths and varying degrees of ethoxylation. Frequently such mixtures also contain some non-ethoxylated alkyl sulphate (“AS”) materials.

The composition may comprise comprises between 0.01 wt. % and 20 wt. % of at least one surfactant, based on the total weight of the composition, preferably between 0.05 wt. % and 15 wt. %, more preferably between 0.1 wt. % and 10 wt. %, even more preferably between 0.5 wt. % and 5 wt. %, most preferably between 0.5 wt. % and 4 wt. %.

In a preferred embodiment, the composition comprises between 0.5 wt. % and 4 wt. % of at least one surfactant, based on the total weight of the composition; wherein the at least one surfactant comprises at least one anionic surfactant and at least one non-ionic surfactant having the formula R1(OCH₂CH₂)ₙOH; wherein R1 is an alkyl moiety having between 10 and 24 carbon atoms, and n has an average value of from 1 to 10. The present inventors have observed that this combination of surfactants is bleach-stable and help to preserve the activity of both the bleaching agent and the dye transfer inhibitor system.

### Enzymes

The composition may further comprise at least one enzyme, preferably selected from the group consisting of a mannanase, a lipase, an amylase, a cellulase, a protease, and combinations thereof.

The person skilled in the art will understand that enzymes are normally added to compositions as enzyme preparations containing between 0.05 wt. % and 10 wt. % of active enzyme.

The composition may comprise between 0.001 wt. % and 10 wt. % of at least one active enzyme, based on the total weight of the composition, preferably between 0.001 wt. % and 7.5 wt. %, more preferably between 0.001 wt. % and 5 wt. %, even more preferably between 0.001 wt. % and 2 wt. % of active enzyme.

The compositions of the present invention may take any form, e.g. solid, liquid, gel, powder or mixtures thereof. Preferably, the compositions will be in form of a solid, a powder or mixtures thereof.

The composition is preferably a laundry detergent composition or a laundry additive composition, more preferably the composition is a laundry additive composition.

The pH of a dilution of 1:100 at 20° C. of the composition may be between 8 and 12, preferably between 9 and 11.5, more preferably between 9.5 and 11.5, even more preferably between 10 and 11.

Preferably the composition further comprises a rheology modifier agent, a fragrance, a phase stabilizer, a dye, a softening agent, a chelating agent, an anti-bacterial agent, a transition metal compound, an anti-foaming agent, a preservative, one or more fillers, an optical brightener, or combinations thereof.

### Fillers

The composition may optionally contain a filler. Suitable fillers include bicarbonates and carbonates of metals, such as alkali metals and alkaline earth metals. Examples include sodium carbonate, sodium bicarbonate, calcium carbonate, calcium bicarbonate, magnesium carbonate, magnesium bicarbonate and sesqui-carbonates of sodium, calcium and/or magnesium. Other examples include metal carboxy glycine and metal glycine carbonate. Chlorides, such as sodium chloride; citrates; and sulphates, such as sodium sulphate, calcium sulphate and magnesium sulphate, may also be employed. Preferably the composition comprises at least one filler selected from the group comprising alkyl carbonate, alkyl sulphate and combinations thereof; more preferably selected from the group comprising sodium carbonate, sodium sulphate and combinations thereof.

When a filler is present, the composition may comprise between 0.1 wt. % and 80 wt. % of said at least one filler, based on the total weight of the composition, preferably between 10 wt. % and 75 wt. %, more preferably between 20 wt. % and 70 wt. %, even more preferably between 30 wt. % and 55 wt. %.

### Optical Brightener

The composition may comprise an optical brightener, preferably selected from the group comprising stilbene, benzidine, benzothiazole, benzimidazole, benzoxazole, coumarin, pyrazoline, naphtalimide, naphtoxazole, distyryl-biphenyl, benzonitrile, benzopyrazole, including their derivatives and substituted compounds, and combinations thereof. Suitable optical brighteners include 4,4′-bis(2-sulphostyryl)diphenyl, 7-Diethylamino-4-methylcoumarin, benzoxazole, 2,2′-(1,2-ethenediyl) bis[5-methyl] including their substituted compounds, 4,4′-bis (triazine-2ylamino) stilbene-2,2′-disulphonic acid, mono (azol-2-yl) stilbene and bis (azol-2yl) stilbene; styryl derivatives of benzene and biphenyl, such as 1,4-bis (styryl) benzene, 4,4′-bis (styryl) benzene, 4,4′-bis-(styryl) biphenyl, 4,4′-bis (sulphostryryl) biphenyl sodium salt; pyrazolines such as 1, 3-diphenyl-2-pyrazoline; bis (benzene-2-yl) derivatives, bis (benzoxazol-2-yl) derivatives and bis (benzimidazol-2-yl) derivatives; 2-(benzofuran-2-yl) benzimidazole; coumarins such as 4-methyl-7-hydroxy-coumarin or 4-methyl-7-diethylaminocoumarin; carbostyrils; naphthalimides; dibenzothiophene5,5-dioxide; pyrene; or pyridotriazole derivatives and combinations thereof.

When an optical brightener is present, the composition may comprise between 0.001 wt. % and 1 wt. % of at least one optical brightener, based on the total weight of the composition, preferably between 0.01 wt. % and 0.5 wt. %, more preferably between 0.05 wt. % and 0.25 wt. %.

In a second aspect, the invention relates to a method of washing a garment, comprising:
washing a garment with the laundry composition according to the first aspect; or
washing a garment with a mixture comprising a laundry detergent composition and the laundry composition according to the first aspect; or
adding a laundry composition according to the first aspect to a bucket with water and soaking for a predetermined length of time; or
a) pre-treating the garment with the laundry composition according to the first aspect; and
b) washing the pre-treated garment of step a) with the laundry composition according to the first aspect, or a laundry detergent composition, or with a mixture comprising a laundry detergent composition and the laundry composition according to the first aspect.

The garment may be made of a wide range of materials, such as cotton, linen, and synthetic materials.

A garment may be washed by adding certain amount; e.g. 60 g, of the composition according to the first aspect of the invention to a washing machine and washing the garment following a regular cycle of said machine.

In a preferred embodiment, a garment with a mixture comprising a laundry detergent composition and between 10 g and 200 g of the laundry composition according to the first aspect, preferably between 20 g and 150 g, more preferably between 30 g and 100 g, even more preferably between 40 g and 80 g. This mixture may be added to a washing machine and the garment may be then washed following a regular cycle of said machine. The proportion in weight of regular detergent composition to the laundry composition according to the invention in the mixture may be (weight of detergent composition: weight of composition according to the invention) 1:5, for example 1:4, preferably 1:3, or even 1:2 or 1:1.

A garment may be also washed by firstly pre-treating the garment with the composition according to the first aspect of the invention and then washing the pre-treated garment using a regular cycle of a washing machine to which, the composition according to the invention, or a regular laundry detergent composition or a mixture comprising a laundry detergent composition and the laundry composition according to the invention has been added. Said pre-treatment comprises for example applying an effective amount of the composition according to the first aspect to a stain on the garment, allowing the composition to act for certain amount of time, for example 1 to 45 minutes, preferably 10 minutes, and rubbing it against itself.

In a third aspect, the invention relates to a use of the laundry composition according to the first aspect for the removal of stains from a garment and dye transfer reduction or inhibition from a garment.

In an embodiment, the stains comprise a polyphenolic compound, preferably the stains comprise turmeric and/or curry stains.

The garment may be made of cotton, synthetic materials or a combination thereof.

In a further aspect, the invention relates to the use of the composition according to the first aspect for the reduction or elimination of bacteria, viruses, germs and/or fungi from a garment.

The foregoing aspects may be freely combined with any of the foregoing aspects disclosed herein.

The invention will be further described, by way of example, with the reference to the following non-limiting embodiments.

### EXAMPLES

### Formulations

Table 1 shows:
comparative compositions (compositions A and B) comprising a copolymer of 1-vinyl-2-pyrrolidone and 1-vinylimidazole (PVP-VI), and
a composition according to the invention (composition 1), which comprises a mixture of a copolymer of 1-vinyl-2-pyrrolidone and 1-vinylimidazole (PVP-VI) and a homopolymer of 1-vinyl-2-pyrrolidone (PVP).

The compositions were prepared by mixing the different raw materials and they were in the form of a powder.

TABLE 1
Laundry compositions

| | Composition | | |
|---|---|---|---|
| Ingredient | A | B | 1 |
| Sodium Carbonate | 13.00 | 13.00 | 13.00 |
| Sodium Sulphate | 38.45 | 42.32 | 42.74 |
| Sodium Percarbonate | 40.00 | 36.00 | 36.00 |
| TAED | 4.00 | 4.00 | 4.00 |
| Non-ionic surfactant | 0.25 | 0.25 | 0.25 |
| Anionic surfactant | 2.00 | 2.00 | 2.00 |
| Protease | 0.29 | 0.30 | 0.30 |
| Mannanase | 0.15 | 0.10 | 0.10 |
| Lipase | 0.20 | 0.20 | 0.20 |
| Amylase | 0.064 | 0.064 | 0.064 |
| Cellulase | 0.10 | 0.20 | 0.20 |
| Fragrance | 0.30 | 0.30 | 0.30 |
| PVP-VI | 0.20 | 0.27 | 0.20 |
| PVP | 0.00 | 0.00 | 0.15 |
| Additional ingredients | q.s. | q.s. | q.s. |

In Table 1:
Non-ionic surfactant: ethoxylated alcohol with a hydrophobic chain having between 12 and 16 carbon atoms. Ethoxylation degree between 4 and 5.
PVP-VI: copolymer of 1-vinyl-2-pyrrolidone and 1-vinylimidazole with a molecular weight of about 70 000 g/mol
PVP: the homopolymer of 1-vinyl-2-pyrrolidone with a molecular weight of 40 000 g/mol.
Enzyme concentrations are of the enzymes as received, i.e. an enzyme preparation.
Additional ingredients: fillers.

The pH of the compositions at 1 wt. % dilution at room temperature is between 10.0 and 11.00

### Performance Tests

### Colour Fading and Colour Transfer—Laundry Washing Machine

### Fabrics

### Donors:

### Cotton Sleeves:

Purple, blue, brown, black, light blue, light green, orange, or yellow—on WFK10A
Purple, blue, brown, black, light blue, light green, orange, or yellow—on E221
blue, brown, black, light blue, light green, orange, or yellow—on tic400

### Acceptors:

White sleeves made of cotton.

### Washing Conditions

The fabrics were washed at 40° C. using water with a hardness of 28° F. and one of the detergent systems shown in Table 2 in a laundry washing machine with the following specifications:
Washing machine: BOSH WAY28740.
Wash cycle: cotton cycle 1 h 40 m.
Load: 3.5 Kg.

Table 2 shows the different detergent systems that were added to the washing machine.

TABLE 2
Detergent systems

| Detergent | |
|---|---|
| system | Components |
| A | 60 g of Composition A and 35 mL of commercial detergent |
| 1 | 60 g of Composition 1 and 35 mL of commercial detergent |

In table 2, the commercial detergent is Ariel Original liquid as sold in the UK.

### Colour Transfer

Colour transfer was determined using a Datacolor 650 spectrophotometer and by measuring the total colour difference (dE) of an acceptor fabric before washing and after having been washed with a donor fabric. A lower dE represents less colour transfer.

TABLE 3
Colour transfer to an acceptor fabric

| | dE | dE | dE |
|---|---|---|---|
| | Detergent | Detergent | Detergent |
| Donor Fabric | system A | system B | system 1 |
| Purple on WFK10A | 4.8 | | 4.5 |
| Blue on WFK10A | 15 | | 7.1 |
| Brown on WFK10A | 12.4 | | 12.4 |
| Black on WFK10A | 5.2 | | 4.2 |
| Light Blue on | 23.6 | | 23.7 |
| WFK10A | | | |
| Light Green on | 16 | | 11.6 |
| WFK10A | | | |
| Orange on WFK10A | 16.2 | | 11.2 |
| Yellow on WFK10A | | 6.37 | 4.43 |
| Purple on E221 | 4 | | 4.6 |
| Blue on E221 | 10.3 | | 4.9 |
| Brown on E221 | 12.9 | | 10.8 |
| Black on E221 | 5.5 | | 4.7 |
| Light Blue on E221 | 24.3 | | 18.9 |
| Light Green on E221 | 13.1 | | 14.8 |
| Orange on E221 | 12 | | 11.1 |
| Yellow on E221 | | 9.20 | 7.26 |
| Purple on tic400 | 2.8 | | 2.6 |
| Blue on tic440 | 10.7 | | 7.2 |
| Brown on tic440 | 11.4 | | 10.6 |
| Black on tic400 | 3.5 | | 4 |
| Light Blue on tic400 | 19.9 | | 14.1 |
| Light Green on tic440 | 12.5 | | 9.9 |
| Orange on tic440 | 11.2 | | 16.5 |
| Yellow on tic440 | | 7.92 | 4.78 |
| Average | 11.77 | | 9.97 |

From table 3, it is clear that the laundry composition according to the invention, in particular in combination with a laundry detergent composition, provides dye transfer inhibition, even from garments in the yellow range.

Stain removal—laundry washing machine

The stain removal performance of different detergent systems was tested using standard soils.

### Washing Conditions

The standard soils were washed at 30° C. using water with a hardness of 28° F. of and one of the detergent systems shown in Table 2 in a laundry washing machine with the following specifications:
Washing machine: Bosch WAY 28740 IT.
Wash cycle: cotton, water in main wash: 15 L, time of main wash: 45 min.
Load: 3.5 Kg of clean, white laundry

After washing, the test swathes were dried at room temperature, i.e. about 25° C., and ironed with a domestic iron.

### Stain Removal

Stain removal was determined using a Datacolor 650 spectrophotometer and by measuring the Y-value of the standard soil after washing. A higher Y-value represents a better stain removal.

TABLE 4
Removal of enzymatic, bleachable and greasy stains.

| | | | Y- values | |
|---|---|---|---|---|
| | | | Detergent | Detergent |
| | Standard soil | Description | system A | system 1 |
| Enzym- | 033KC | Chocolate Bar | 86.76 | 87.16 |
| atic | W-10Z | Chocolate | 65.93 | 65.08 |
| | C-S-27 | potato starch/ | 70.37 | 70.70 |
| | | colorant | | |
| | C-S-406 | Balsamic Dressing | 65.82 | 65.58 |
| | WE5DASBKC | sheep blood | 87.26 | 87.67 |
| | | Average | 75.23 | 75.24 |
| Deter- | 160KC | collar stain | 64.30 | 67.20 |
| gency | 160KPC | collar stain | 76.44 | 76.87 |
| | C-H064 | curry with oil | 78.34 | 79.39 |
| | C-H208 | Turmeric with oil | 74.49 | 76.78 |
| | C-S-132 | High discriminative | 64.46 | 65.26 |
| | | sebum bey with | | |
| | | pigment | | |
| | RB-019 | synthetic sebum | 83.66 | 84.35 |
| | | astm method | | |
| | W-10D | skin grease/pigment | 68.81 | 71.09 |
| | W-10MU | make up | 76.36 | 76.31 |
| | W-10RM | Soot mineral oil, | 30.06 | 29.36 |
| | | IEC | | |
| | W-10V | soy sauce | 88.18 | 88.32 |
| | WE5BBWKC | cooked beef fat | 85.82 | 85.07 |
| | | Average | 71.90 | 72.73 |
| Bleach- | C-S-08 | grass | 81.45 | 81.88 |
| able | C-S-15 | blueberry juice | 67.31 | 66.14 |
| | C-S-34 | curry | 76.79 | 79.59 |
| | W-10SG | spaghetti sauce with | 62.50 | 62.49 |
| | | meat | | |
| | WE5ECWKC | coffee | 83.76 | 82.37 |
| | WE5FSMWKC | French squeeze | 81.89 | 81.62 |
| | | mustard | | |
| | WE5GMWKC | Grass/Mud | 49.48 | 48.11 |
| | WE5LTWKC | tea | 64.87 | 64.90 |
| | WE5RWWKC | Red wine | 75.65 | 74.56 |
| | WE5TPWKC | tomato puree | 77.47 | 78.31 |
| | | Average | 72.12 | 72.00 |

From table 4, it is clear that the laundry composition according to the invention, in particular in combination with a laundry detergent composition, also provides stain removal, in particular, removal of stains comprising a polyphenolic compound, such as turmeric and/or curry stains.

Hence one or more objects of the present invention are achieved by the present which is further elucidated in the appended claims.

What is claimed is:

1. A laundry additive composition comprising:
at least one bleach activator;
between 10 wt. % and 60 wt. % of at least one bleaching agent, based on the total weight of the laundry additive composition; and
a dye transfer inhibitor system comprising a copolymer of 1-vinyl-2-pyrrolidone and 1-vinylimidazole, and a homopolymer of 1-vinyl-2-pyrrolidone,
wherein the weight ratio between the copolymer of 1-vinyl-2-pyrrolidone and 1-vinylimidazole and the homopolymer of 1-vinyl-2-pyrrolidone is of between 1.2:1 to 4:1.

2. The laundry additive composition according to claim 1, wherein the copolymer of 1-vinyl-2-pyrrolidone and 1-vinylimidazole has a molecular weight of between 10,000 g/mol and 500,000 g/mol, preferably between 20,000 g/mol and 250,000 g/mol, more preferably between 30,000 g/mol and 150,000 g/mol, even more preferably between 40,000 g/mol and 100,000 g/mol.

3. The laundry additive composition according to claim 1, wherein the homopolymer of 1-vinyl-2-pyrrolidone has a molecular weight of between 10,000 g/mol and 200,000 g/mol, preferably between 20,000 g/mol and 100,000 g/mol, more preferably between 30,000 g/mol and 50,000 g/mol, even more preferably between 35,000 g/mol and 45,000 g/mol.

4. The laundry additive composition according to claim 1, wherein the weight ratio between the copolymer of 1-vinyl-2-pyrrolidone and 1-vinylimidazole and the homopolymer of 1-vinyl-2-pyrrolidone is between 1.2:1 to 3:1, preferably between 1.3:1 to 2:1.

5. The laundry additive composition according to claim 1, wherein the laundry additive composition comprises between 0.01 wt. % and 10 wt. % of the dye transfer inhibitor system, based on the total weight of the laundry additive composition, preferably between 0.05 wt. % and 7.5 wt. %, more preferably between 0.1 wt. % and 5 wt. %, even more preferably between 0.2 wt. % and 2.5 wt. %.

6. The laundry additive composition according to claim 1, wherein the laundry additive composition comprises between 20 wt. % and 55 wt. % of the at least one bleaching agent, based on the total weight of the laundry additive composition, preferably between 30 wt. % and 50 wt. %, more preferably between 35 wt. % and 45 wt. %.

7. The laundry additive composition according to claim 1, wherein the at least one bleaching agent comprises at least one source of active oxygen selected from the group consisting of an inorganic peroxide, an organic peracid, hydrogen peroxide, and combinations thereof; preferably selected from the group consisting of sodium percarbonate, ε-phthalimido-peroxy-hexanoic acid (PAP), peracetic acid, potassium peroxymonosulfate (KMPS), and combinations thereof; most preferably wherein the at least one bleaching agent comprises sodium percarbonate.

8. The laundry additive composition according to claim 1, wherein the laundry additive composition comprises between 0.1 wt. % and 20 wt. % of the at least one bleach activator, based on the total weight of the laundry additive composition, preferably between 0.25 wt. % and 15 wt. %, more preferably between 0.5 wt. % and 10 wt. %, most preferably between 1 wt. % and 5 wt. %.

9. The laundry additive composition according to claim 1, wherein the laundry additive composition comprises between 0.01 wt. % and 20 wt. % of at least one surfactant, based on the total weight of the laundry additive composition, preferably between 0.05 wt. % and 15 wt. %, more preferably between 0.1 wt. % and 10 wt. %, even more preferably between 0.5 wt. % and 5 wt. %, most preferably between 0.5 wt. % and 4 wt. %.

10. The laundry additive composition according to claim 1, wherein the laundry additive composition further comprises at least one enzyme, preferably selected from the group consisting of a mannanase, a lipase, an amylase, a cellulase, a protease, and combinations thereof.

11. The laundry additive composition according to claim 1, wherein the pH of a dilution of 1:100 at 20° C. of the laundry additive composition is between 8 and 12, preferably between 9 and 11.5, more preferably between 9.5 and 11.5, even more preferably between 10 and 11.

12. The laundry additive composition according to claim 1, wherein the laundry additive composition is in the form of a solid, a powder, or mixtures thereof.

13. (canceled)

14. A method of washing a garment, comprising:
washing a garment with the laundry additive composition according to claim 1; or
washing a garment with a mixture comprising a laundry detergent composition and the laundry additive composition according to claim 1; or
adding a laundry additive composition according to claim 1 to a bucket with water and soaking for a predetermined length of time; or
a) pre-treating the garment with the laundry additive composition according to claim 1; and
b) washing the pre-treated garment of step a) with the laundry additive composition according to claim 1, or a laundry detergent composition, or with a mixture comprising a laundry detergent composition and the laundry additive composition according to claim 1.

15. A method of using the laundry additive composition according to claim 1 for the removal of stains from a garment and dye transfer reduction or inhibition from a garment, the method comprising:
washing a garment with the laundry additive composition according to claim 1; or
washing a garment with a mixture comprising a laundry detergent composition and the laundry additive composition according to claim 1; or
adding a laundry additive composition according to claim 1 to a bucket with water and soaking for a predetermined length of time; or
a) pre-treating the garment with the laundry additive composition according to claim 1; and
washing the pre-treated garment of step a) with the laundry additive composition according to claim 1, or a laundry detergent composition, or with a mixture comprising a laundry detergent composition and the laundry additive composition according to claim 1.

16. The method of using the laundry additive composition according to claim 15, wherein the stains comprise a polyphenolic compound, preferably wherein the stains comprise turmeric and/or curry stains.
